(19) United States
(12) Patent Application Publication
(10) Pub. No.: US 2018/0290086 A1
(43) Pub. Date: Oct. 11, 2018

(54) Fuel Filter

(71) Applicant: Baldwin Filters, Inc., Kearney, NE (US)

(72) Inventors: Matthew T. Grisham, Rocky Hill, CT (US); Chandrakant Siddharam Kotale, Pune (IN)

(21) Appl. No.: 15/479,727

(22) Filed: Apr. 5, 2017

(51) Int. Cl. B01D 36/00; B01D 29/15; B01D 17/04; F02M 37/22

(52) U.S. Cl. CPC B01D 36/003; B01D 29/15; B01D 17/045; B01D 2201/342; B01D 2201/0415; B01D 2201/291; F02M 37/221

(57) ABSTRACT

A fuel filter element includes an upper endcap, lower endcap, and a tubular filter media extending between the two. A water separator is located substantially within a first annular space defined by the filter media, with which it axially overlaps. A pin projects from the lower end of the filter element to fill a drain at the bottom of a filter enclosure. The filter element supports two seals of different diameters, axially offset from each other and configured to receive a standpipe to define a flow path for separated water to enter the standpipe. The filter element may include a drainage cap which defines an open volume and receives water draining through the lower endcap from a second annular space between filter media and a water separator. The invention further relates to an assembly including a standpipe and configured to mate with the disclosed filter element.

### BACKGROUND

The present disclosure relates generally to devices for filtering and separating liquids. More particularly, the present disclosure relates to fuel filters for removing foreign particles and separating water from fuel delivered to an internal combustion engine.

Modern internal combustion engines require extremely clean fuel with minimal particulate content and water. Fuel filter assemblies are arranged in the fuel delivery path to separate water and particulates from fuel before it is delivered to vehicle systems that will pressurize and inject the fuel for combustion. Fuel filter assemblies may include one or more replaceable filter elements or cartridges where fuel is routed through filter media and water separating structures. The fuel filter assemblies are constructed to permit easy replacement of the filter element or cartridge at regular service intervals. Filter media is typically a non-woven web of fibrous material constructed to trap and retain abrasive particles, removing them from the fuel flow. Filter media may also be treated to be hydrophobic, which causes entrained water to be rejected at the inlet face of the media. Alternatively, coalescing media may encourage dispersed water to coalesce into larger droplets, which are then separated using a hydrophobic water separator, such as a polymer screen with very small openings. Separated water is provided a flow path where gravity can assist the separated water to flow into a water accumulation reservoir for later disposal.

A filter cartridge typically includes its own housing, which routes fuel through filter media and water separation structures. A filter cartridge housing may incorporate structures for removably mounting the cartridge to a filter head, or may be engaged by a collar or other structure to mount the cartridge to a filter head. Alternative filter assemblies employ a permanent filter housing in combination with a removable filter element. The filter element includes means for engaging fuel flow paths defined by the filter assembly and routing fuel through filter media and water separation structures. All fuel filter assemblies are subject to spatial constraints, meaning that the requisite filtration and water separation functions must be performed in a compact configuration.

### SUMMARY

The disclosure relates to a fuel filter element configured for mounting over a standpipe within a filter housing. The filter element has a longitudinal axis and comprises a first or upper endcap and a second or lower endcap. The lower endcap is axially spaced from the upper endcap along the longitudinal axis of the filter element and itself defines a central opening as well as one or more flow openings for separated water. Each flow opening for separated water is radially offset from the central opening.

The filter element also comprises a tubular formation of filter media which extends between the upper endcap and the lower endcap. The filter media may be pleated, and defines a first annular space within the filter element. An axis is also defined by the filter media, which may be co-axial with the longitudinal axis of the filter element.

The filter element may also comprise a water separator axially overlapping and substantially coaxial with the filter media. The water separator may be located radially inward of the filter media and may, together with the filter media, define a second annular space radially between the filter media and the water separator. This second annular space is in fluid communication with at least one flow opening in the lower endcap.

The filter element may also comprise a first seal as well as a second seal supported by the lower endcap. If both seals are present, they may be coaxial. Each seal is supported by the filter element and arranged so as to engage the standpipe projecting upward from the filtration housing while creating a seal with that standpipe. In such an orientation, the first and second seals may be axially spaced from the upper endcap, and may be closer to the lower endcap than the upper endcap. The first seal may have a first diameter and may be axially spaced from the second seal, which may have a second diameter. This second diameter may be greater than the first seal's first diameter. A region may be defined between the first and second seals which may be in fluid communication with a flow opening defined by the standpipe. The first and second seals supported by the filter element may thus be spaced and located so as to enable a flow path for separated water through the flow openings defined by the lower endcap to communicate with the flow opening defined by the standpipe while sealingly preventing dry filtered fuel from flowing to the flow opening defined by the standpipe.

The filter element may also comprise a pin which may be supported below the lower endcap. This pin may project away from the upper endcap and may be located radially outside of the central opening. The pin may project along an axis parallel to the longitudinal axis of the filter element.

The filter element may also comprise a center tube substantially within the first annular space defined by the filter media. The center tube may be integrally formed with the water separator. The center tube may also at least partially radially support the filter media. The center tube may also itself comprise one or more ribs, each of which may direct fluid flow from radially outside of the water separator towards the lower endcap.

The first seal of the filter element may define a first opening which may be smaller in diameter than a second opening which may be defined by the second seal.

The water separator of the filter element may extend at least 75% of the distance between the upper endcap and the lower endcap.

The second seal may be engaged with the central opening of the filter element. The first seal may be engaged with the central opening of the filter element. The first seal may also be engaged with either the center tube or the water separator.

The filter element may also comprise a drainage cap which may be configured to receive fluid through a flow opening and may define an open volume. The drainage cap may comprise a first end which may define a third opening and may comprise a second end which may define a fourth opening. The second seal may be engaged with this fourth opening. The first seal may be located substantially within the open volume defined by the drainage cap, though it may also be substantially within the first annular space defined by the filter media. The first seal may also be engaged with the central opening, though it may also be engaged with the center tube.

In an alternate embodiment, the filter element may comprise an upper endcap, which may incorporate an air bleed seal, a lower endcap, which may define a central opening and may also define at least one flow opening which may be located radially outward of the central opening, and a substantially cylindrical formation of filter media, which may extend between the upper endcap and the lower endcap, may be sealingly engaged with the upper endcap and the lower endcap, and may define a first annular space. The filter element may further comprise a water separator which may be at least partially within the first annular space and may be substantially axially aligned with the filter media. The filter element may also comprise a center tube, which may be integrally formed with and may be radially surrounding the water separator. The center tube may itself comprise one or more ribs which may define a second annular space between the filter media and the water separator. The second annular space may be in fluid communication with at least one flow opening.

This filter element may also comprise a drainage cap which may be configured to receive fluid through at least one flow opening and may define an open volume. The drainage cap may further comprise a first end which may define a first opening. It may also comprise a second end which may define a second opening. The drainage cap may also comprise a substantially cylindrical member which may be offset radially from an axis located centrally within the second opening defined by the second end and may project from the second end away from the lower endcap.

The filter element may also comprise a first seal engaged with the first opening. This first seal may define a third opening which may have a first diameter and may be configured to sealingly engage with a standpipe within a filter housing. The filter element may also comprise a second seal which may be engaged with the second opening. This second seal may define a fourth opening which may have a second diameter and may be configured to sealingly engage with the standpipe within the filter housing. The third opening may also be coaxial with the fourth opening, and the second diameter may be greater than the first diameter. The first seal may be offset from the second seal along the axis located centrally within the second opening.

The disclosure also relates to an apparatus which comprises a housing which is configured to receive a fuel filter element, and may comprise a standpipe, and a fuel filter element. The filter element may comprise an upper endcap and a lower endcap offset below the upper endcap. The filter element may define a central opening and may also define at least one flow opening located radially outward of the central opening. A tubular formation of filter media may extend between the upper and lower endcaps and may define a first annular space. Coaxial first and second seals may be supported by the fuel filter element and may be arranged to sealingly engage the standpipe when the fuel filter element is mounted over the standpipe within the filter housing. The coaxial first and second seals may be axially offset from the upper endcap and may be closer to the lower endcap than to the upper endcap. The first seal may have a first diameter and may be axially offset from the second seal, which may have a second diameter greater than the first diameter of the first seal. A region between the first and second seals may be in fluid communication with at least one flow opening. Further, a pin may be supported below the lower endcap, may be radially outside of the central opening, and may project away from the upper endcap.

The housing may define a third opening which may be configured to receive the pin.

The filter element of the apparatus may further comprise a water separator which may axially overlap and may be substantially coaxial with the tubular formation of filter media. The water separator may be located radially inward of the filter media and may define a second annular space radially between the filter media and the water separator. The second annular space may be in fluid communication with at least one flow opening.

An embodiment of the filter element is further characterized in implementing a two stage filtration system, where fuel is filtered through filter media. This filter substantially blocks the flow of particulates passing from the dirty fuel side of the media to the clean fuel side of the media. The media here has an additional benefit of functioning as a water coalescer without requiring an additional component to perform this function. Water thus coalesced is then separated from the fuel as it passes through the water separator. Separated water may then flow out of the filter cartridge, or it may flow into a drainage cap, where it is collected and then discharged as needed.

It is to be understood that the above mentioned features and the features yet to be explained hereinafter can be used not only in the respectively mentioned combination but also in other combinations or alone without departing from the context of the present invention.

### BRIEF DESCRIPTION OF THE DRAWING

The invention is now disclosed in detail with reference to exemplary embodiments shown in the accompanying drawings, where:

FIG. 1 shows a cross-sectional view of one embodiment of a filtration housing and filter cartridge assembly of the present disclosure.

FIG. 2 shows an isometric view of one embodiment of a filter element of the present disclosure;

FIG. 3 shows a cross-sectional view of the embodiment of FIG. 2;

FIG. 4 shows an isometric view of one embodiment of a center tube of the present disclosure;

FIG. 5 shows a cross-sectional view of the lower endcap of FIG. 3, including an upper seal;

FIG. 6 shows a cross-sectional view of an alternate embodiment of a filter element of the present disclosure, including flow paths;

FIG. 7 shows a cross-sectional view of another alternate embodiment of a filter element of the present disclosure;

FIG. 8 shows a top view of the lower endcap of FIG. 3, without a seal;

FIG. 9 shows an isometric view of the lower endcap of FIG. 7; and

FIG. 10 shows a cross-sectional isometric view of another alternate embodiment of a filter element of the present disclosure;

### DETAILED DESCRIPTION

Exemplary embodiments of the disclosed fuel filter are illustrated in the Figures and are explained in the following description in more detail, wherein identical reference numbers refer to identical or similar components.

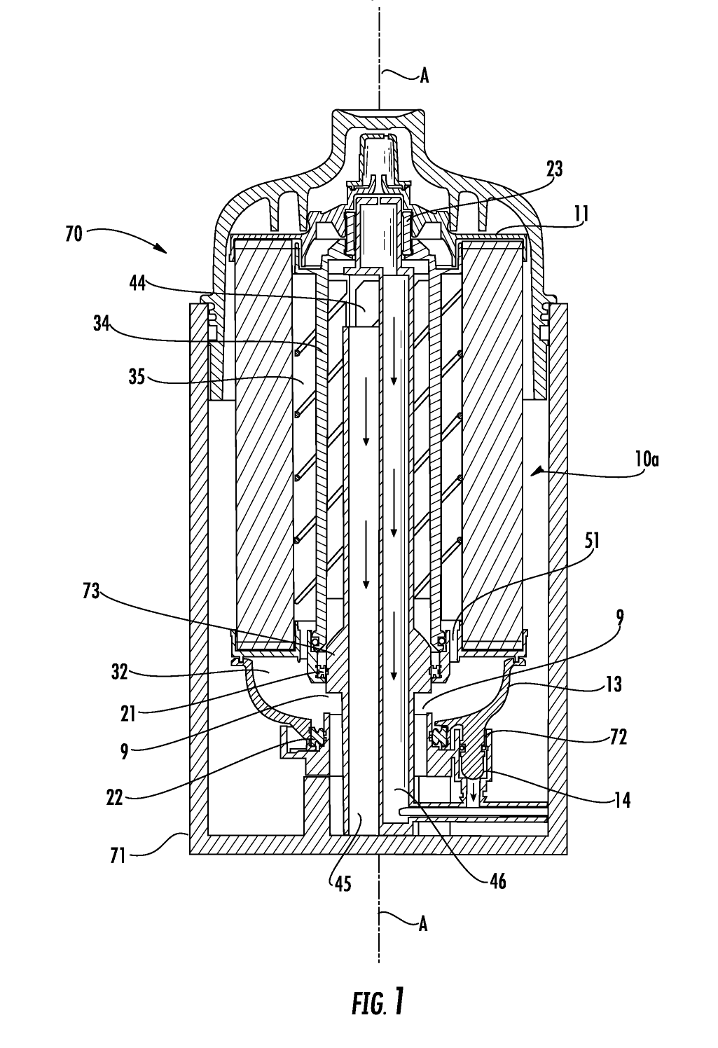

FIG. 1 shows a cross-sectional view of an embodiment of an assembly 70 comprising the filter housing 71 and an embodiment of the fuel filter element 10a according to aspects of the disclosure. The fuel filter element 10a assembles onto the filter housing 71 such that a plug or pin 14 is received by a drain opening 72. According to aspects of the disclosure, the filter assembly will not function if the drain opening 72 is sealed by a member like the pin 14. When fully assembled, a standpipe 73 will extend into the fuel filter element 10a through an upper seal 21. The first exemplary embodiment of the filter element 10a also includes a drainage cap 13. In this embodiment, the pin 14 is cylindrical and has a blunt, rounded end. The pin 14 extends from the drainage cap 13. The pin 14 is radially offset from an axis A passing through the standpipe 73. A lower seal 22 is supported by the drainage cap 13. With the exception of the pin 14, the filter element 10a is rotationally symmetrical with respect to axis A.

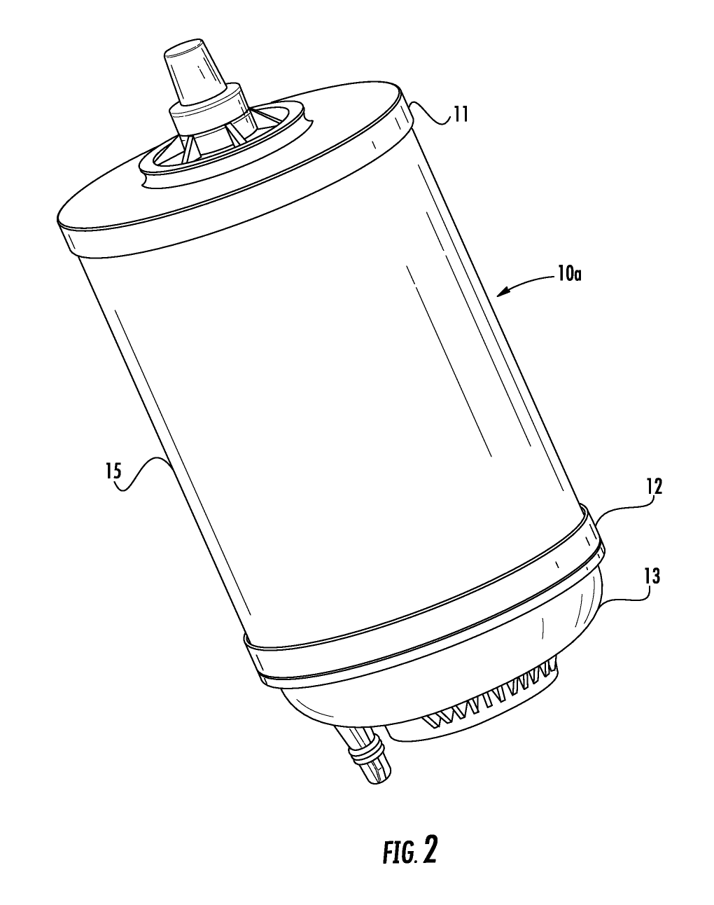

FIG. 2 further illustrates this embodiment of the filter element 10a. The filter element 10a comprises an upper endcap 11 and a lower endcap 12. Filter media 15 extends axially between the upper endcap 11 and the lower endcap 12. In this exemplary embodiment, the filter media 15 is a pleated media which is assembled into a generally tubular configuration.

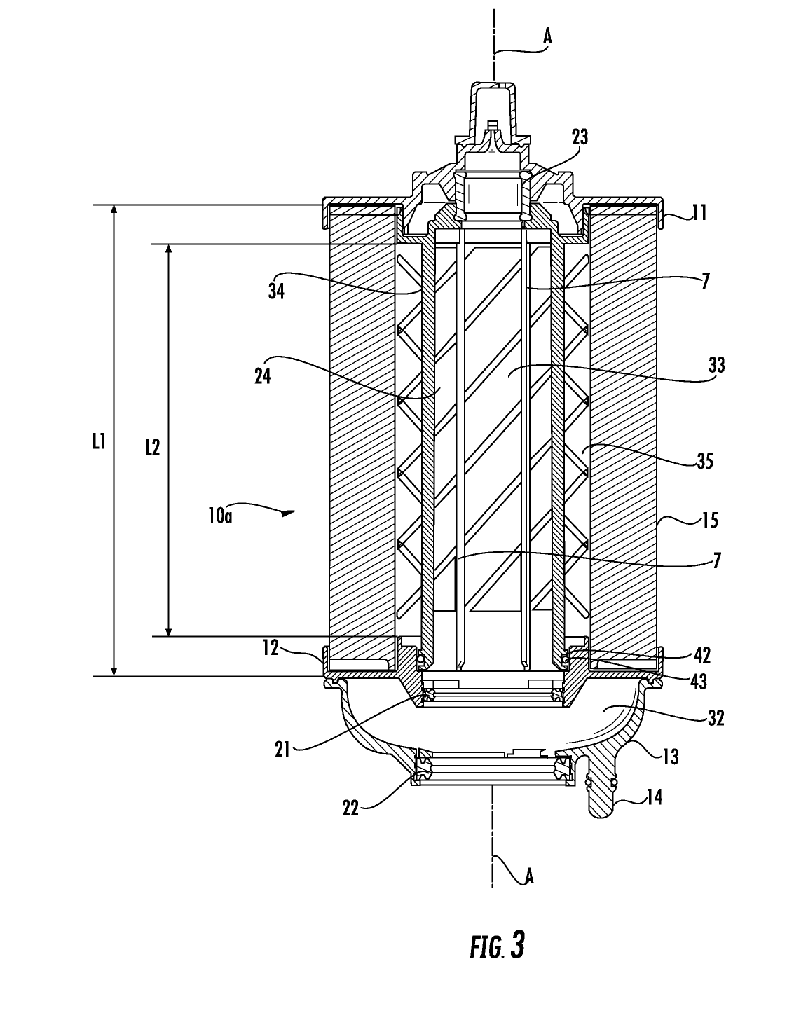

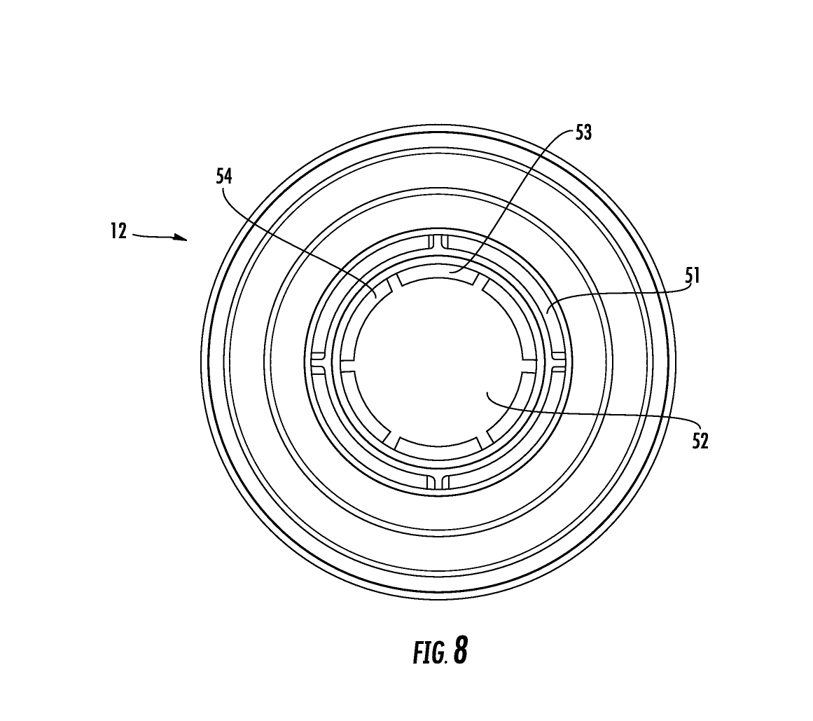

FIG. 3 shows another cross-sectional view of the filter element 10a of FIGS. 1 and 2. The drainage cap 13, which is attached to the lower endcap 12, defines an open volume 32. The filter media 15, shown to be in a tubular configuration in this embodiment, defines a first annular space 33, and a water separator 24 is shown therein. The first annular space 33 contains a center tube 34. The water separator 24 is coaxial with the filter media 15 and is at least partially within the first annular space 33 defined by the filter media 15. The water separator 24 preferably extends about 75% of the axial length of the filter media 15, as shown by the difference between the length of the filter media L₁ and the length of the water separator L₂. In the embodiment of FIGS. 1-3, separated water flows through one or more flow openings 51 in the lower endcap 12, as shown in FIG. 8, and then enters the open volume 32 of the drainage cap 13. The upper seal 21 is supported by the lower endcap 12 while a lower seal 22 is supported by the drainage cap 13. Both seals 21, 22 define openings which are axially aligned with each other, though they are offset from each other along axis A, resulting in sealed engagement with different locations along the length of the standpipe 73 above and below openings 9. The opening defined by the upper seal 21 and the opening defined by the lower seal 22 may also be of different diameters, as the standpipe 73 that they are configured to receive may have a larger diameter at its base than where it engages the upper seal 21. When the filter element 10a of this embodiment is assembled to the filter housing 71, the standpipe 73 passes through the lower seal 22, the open volume 32, and into the upper seal 21. In this way, separated water is not able to return to the purified fuel flow or to leak out of the drainage cap 13 except through openings 9 in the standpipe 73. Lower seal 22 separates dirty incoming fuel, from outside the filter element 10a, from clean wet fuel, which has passed through the filter media 15 and is in a second annular space 35 or the open volume 32. The second annular space 35 is defined radially outwardly by the inside surface of the filter media 15 and radially inwardly by the outside surface of the water separator 24.

An air bleed seal 23 is shown at the top of filter element 10a, engaged with the upper endcap 11 and upper end of the center tube 34. The air bleed seal 23 permits air inside the filter housing 71 but external to the filter element 10a to enter a designated channel within the center tube 34, accompanied by a small amount of fuel from outside of the filter element 10a. This allows the filter housing 71 to fill with fuel after the element is changed, without pushing large volumes of air downstream.

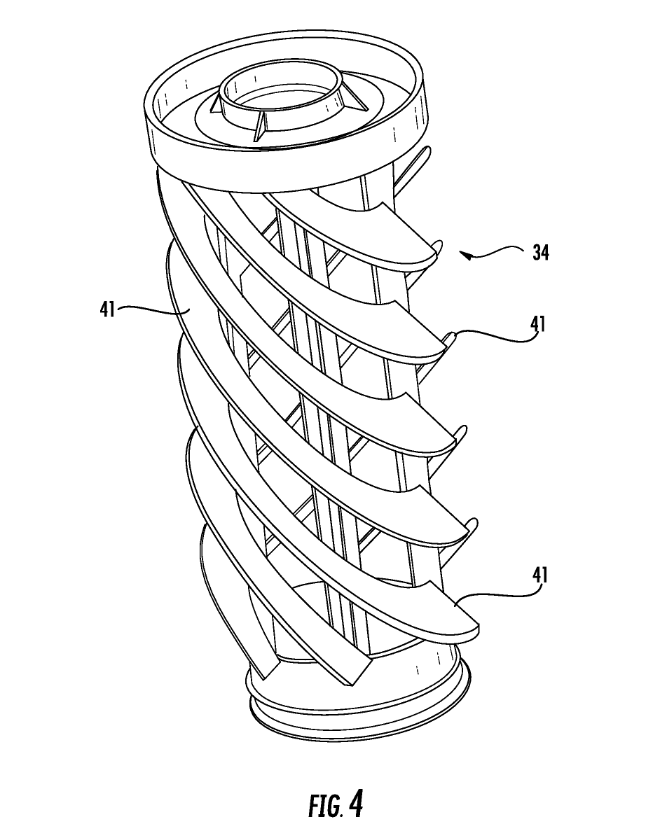

FIG. 4 shows an embodiment of the center tube 34. This embodiment includes one or more spiral ribs 41 which can, with the other features on this center tube 34, at least partially radially support the filter media 15 from within. The one or more ribs 41 in this embodiment may also aid in directing flow of separated water down to the lower endcap 12, and specifically towards the one or more flow openings 51. Vertical ribs 7 support a hydrophobic screen that functions as the water separator 24. Center tube 34 defines a gland 42 for a seal 43 that is compressed against an inside surface of the lower endcap 12. The center tube 34 is sealed to the upper endcap 11 and lower endcap 12 to separate the second annular space 35 outside the water separator 24 from the first annular space 33 inward of the water separator 24 and surrounding the standpipe 73. Clean dry fuel enters the standpipe 73 through opening 44 near the top of the filter assembly 70. Water coalesced from the fuel flowing through the filter assembly 70 falls to the bottom of the second annular space 35 and passes through openings 51 in lower endcap 12 to accumulate in the open volume 32 defined by drainage cap 13. Accumulated water passes through openings 9 in the side of the standpipe 73 located axially between upper seal 21 and lower seal 22.

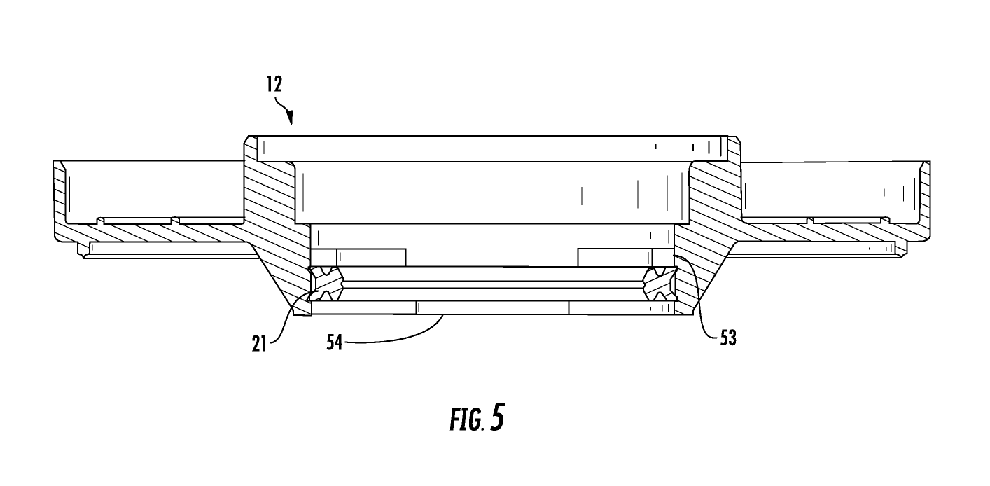

FIG. 5 shows a cross-sectional view of an embodiment of the lower endcap 12 including an interrupted seal, such as the upper seal 21. Upper seal 21 is shown supported on one axial side by one or more upper engagement ridges 53, and on the opposite axial side by one or more lower engagement ridges 54. While the seal in this embodiment is depicted at the lower end of the lower endcap 12, it should also be understood that it may in fact be located higher on the lower endcap 12. If the seal is the upper seal 21, it may be also be engaged with the center tube 34 or water separator 24, depending on the embodiment.

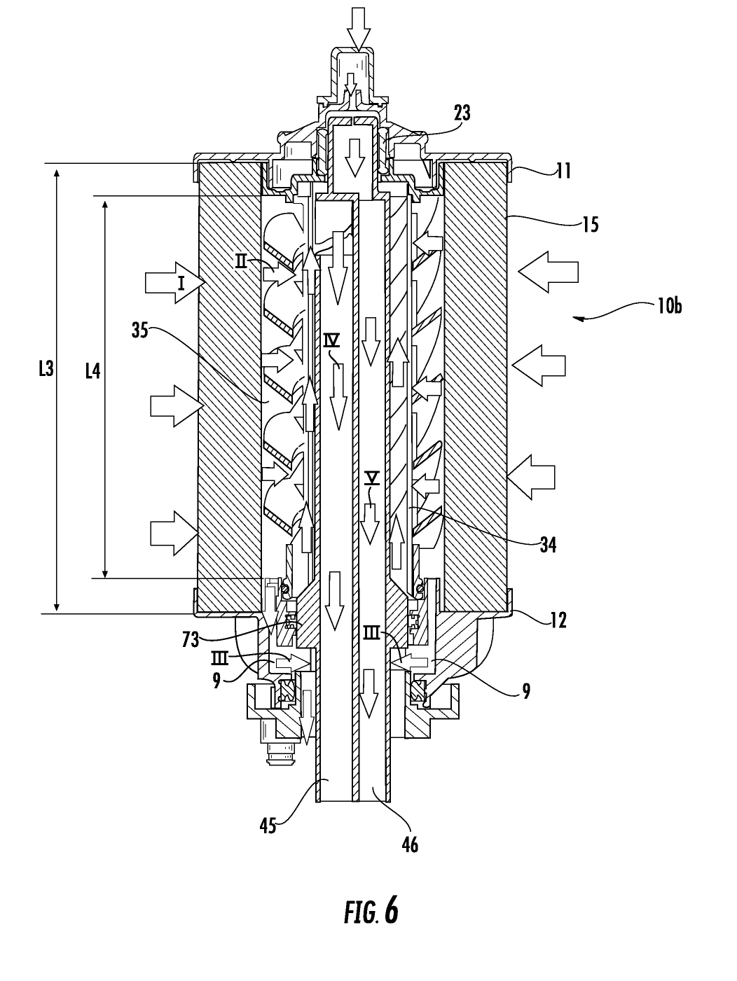

FIG. 6 shows the flow of fuel and water through the filter media 15 of an alternate filter element 10b. Unfiltered wet fuel (I) flows inward radially from outside of the filter media 15, as depicted by the arrows I-V. In this embodiment, the center tube 34 also partially supports the filter media 15, including here at the top of the filter media 15, with ribs 41 partially supporting the filter media 15 radially against collapse or buckling due to the pressure that the filter media is subjected to radially from the outside. The water separator 24 is on the inside radial surface of the center tube 34. Water in the fuel tends to coalesce during its passage through the filter media 15 and enters the second annular space 35 as coalesced droplets. While filtered wet fuel (II) is able to pass through the water separator 24, coalesced water droplets cannot. The separated water (III) then flows through the one or more flow openings 51 in the lower endcap 12 into the open volume 32 defined by the drainage cap 13. In the disclosed embodiment, filtered dry fuel (IV) flows down a designated channel 45 in the standpipe 73. Air and sacrificial fuel (V) flow through the top of the filter element 10b and into an air bleed channel 46 in the standpipe 73. The air bleed channel 46 connects with the drain opening 72 and flows back to the fuel tank (not shown).

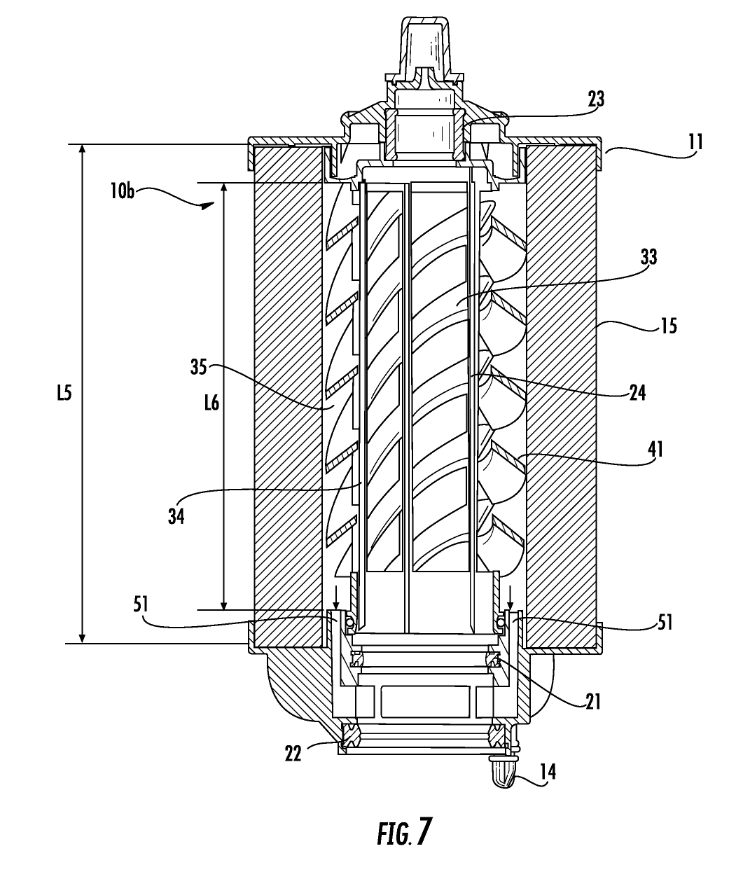

FIG. 7 shows a cross-sectional view of an alternate embodiment of the filter element 10b. Embodiment 10b differs from embodiment 10a primarily with regard to the configuration of the lower endcap 12. Embodiment 10b does not include drainage cap 13, instead supporting lower seal 22 on a downward extension of lower endcap 12. Lower endcap 12 also defines channels 51 for separated water to enter openings 9 in the side of the standpipe 73 axially between the upper seal 21 and lower seal 22. In filter element 10b, shown in FIG. 7, the water separator 24 extends about 80% of the axial length of the filter media 15, as shown by the difference between the length of the filter media L₅ and the length of the water separator L₆. The water separator 24 preferably extends at least 50% of the axial length of the filter media 15 and even more preferably at least 75% of the axial length of the filter media 15, as shown in FIG. 6 by the difference between the length of the filter media L₃ and the length of the water separator L₄. An air bleed seal 23 is captured between parts of the upper endcap 11 and mates with the top of the standpipe 73 to prevent fuel outside the filter element from mixing with fuel that has passed through the filter media 15.

In filter element embodiment 10b, the upper seal 21 and lower seal 22 are both engaged with and supported by the lower endcap 12 with both seal engagement structures included in a single continuous component. However, it is understood that the upper seal 21 could instead engage with the water separator 24 or with the lower end of the center tube 34.

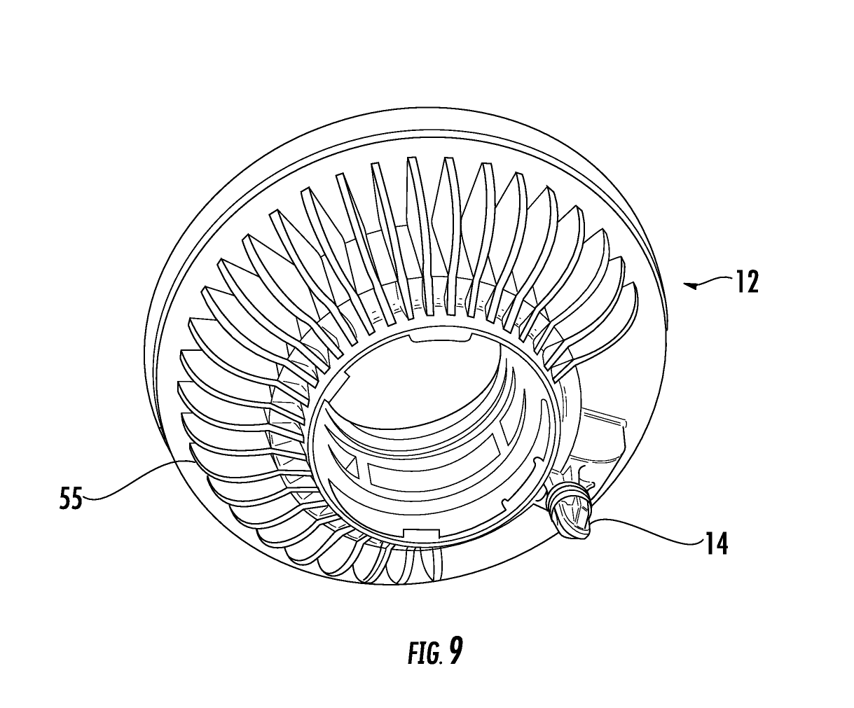

FIG. 8 is a view from above of an embodiment of the lower endcap 12. This view shows the central opening 52, which is here configured to engage and support a seal such as upper seal 21 (removed for clarity, see FIG. 3). This embodiment of the lower endcap 12 also includes multiple flow openings 51, which permit separated water to flow out of the second annular space 35 between the water separator 24 and the filter media 15. If a drainage cap 13 is present below the endcap 12, then the separated water would flow through the one or more flow openings 51 into the open volume 32 defined by the drainage cap 13. In the filter element 10b of FIGS. 6 and 7, the lower endcap defines passages 51 that communicate with openings 9 in the side of the standpipe 73. In a two stage filter element, such as embodiments 10a and 10b, lower seal 22 ensures that separated water flows into openings 9 in the standpipe 73. FIG. 9 is a perspective view of the lower endcap 12 of embodiment 10b. The lower endcap 12 includes a downward extension that supports lower seal 22. A plurality of fins 55 project radially from the extension to simulate the appearance of the drainage cap 13. The pin 14 also projects from the lower endcap 12.

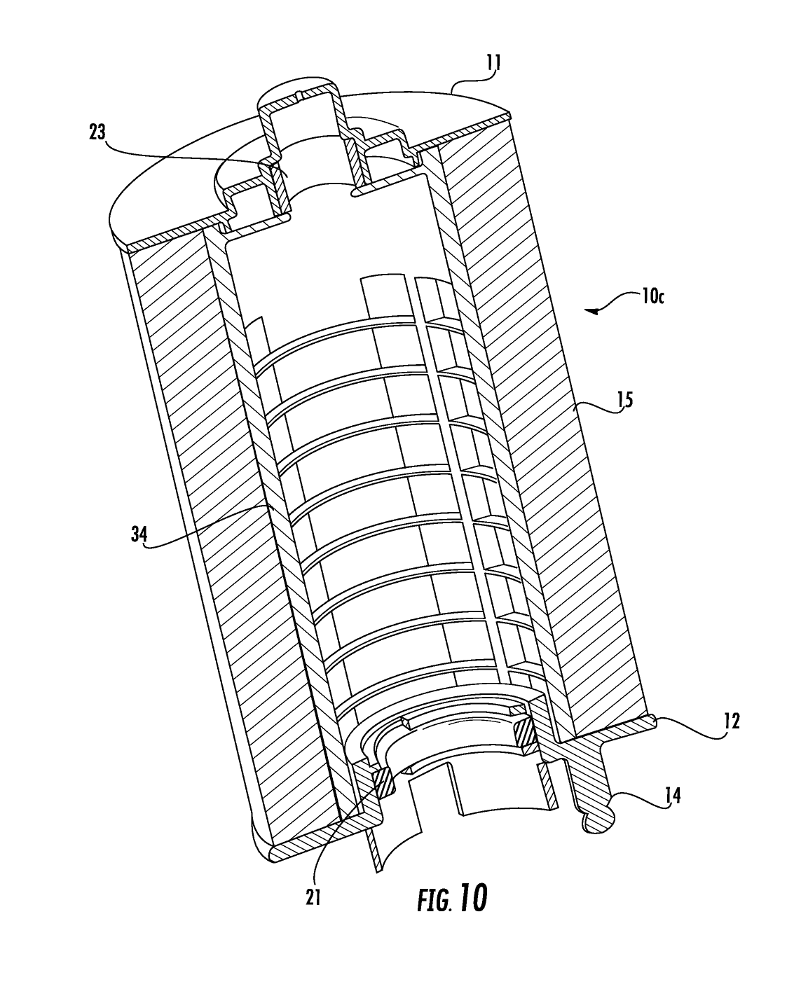

FIG. 10 shows an alternate embodiment of a filter element 10c, shown in cross-section. Filter element 10c is a single stage filter element, with the filter media 15 treated to separate water before the fuel passes radially through the media, as is known in the art. The lower endcap 12 supports upper seal 21 to mate with the standpipe 73 above the radial openings 9. Separated water accumulates at the bottom of the filter housing 71 until high enough to flow into the openings 9 in the standpipe 73. A single stage filter element does not need the lower seal 22, because there is no water separator and no need to separate clean wet fuel from the surrounding fuel. In embodiment 10c, the pin 14 extends from the lower endcap 12.

While multiple embodiments have been set forth for purposes of illustration, the foregoing description should not be deemed a limitation of the invention herein. Accordingly, various modifications, adaptations and alternatives may occur to one skilled in the art without departing from the spirit of the invention and scope of the claimed coverage.

What is claimed is:

1. A fuel filter element for mounting over a standpipe within a filter housing, said fuel filter element having a longitudinal axis and comprising:
an upper endcap;
a lower endcap axially spaced a first distance from the upper endcap and defining a central opening and at least one flow opening radially outward of the central opening;
a tubular formation of filter media substantially encircling the longitudinal axis and extending between the upper and lower endcaps and defining a first annular space;
a water separator axially substantially overlapping and coaxial with the tubular formation of filter media, wherein the water separator is located radially inward of the filter media and with the filter media defines a second annular space radially between the filter media and the water separator, the second annular space being in fluid communication with the at least one flow opening;
coaxial first and second seals supported by the filter element and defining respective first and second openings arranged for the first and second seals to sealingly engage the standpipe when the filter element is mounted over the standpipe within the filter housing, the first seal axially spaced a second distance from the upper endcap and closer to the lower endcap than the upper endcap and the second seal axially spaced a third distance from the first seal, the first seal having a first diameter and the second seal having a second diameter greater than the first diameter, a region between the first and second seals being in fluid communication with the at least one flow opening; and
a pin supported below the lower endcap, radially outside the central opening and projecting away from the upper endcap along a second axis substantially parallel to the longitudinal axis.

2. The fuel filter element according to claim 1, further comprising a center tube substantially within the first open volume.

3. The fuel filter element of claim 2, wherein the center tube and the water separator are integrally formed.

4. The fuel filter element of claim 2, wherein the center tube at least partially radially supports the filter media.

5. The fuel filter element of claim 2, wherein the center tube further comprises one or more ribs, the one or more ribs further directing fluid flow from radially outside of the water separator towards the lower endcap.

6. The fuel filter element according to claim 1, wherein the water separator extends at least 75% of the first distance between the upper endcap and the lower endcap.

7. The fuel filter element according to claim 1, wherein the second seal is engaged with the central opening.

8. The fuel filter element according to claim 7, wherein the first seal is engaged with said central opening.

9. The fuel filter element according to claim 7, wherein the first seal is engaged with the center tube or the water separator.

10. The fuel filter element of claim 1, further comprising a drainage cap configured to receive fluid through the at least one flow opening and defining an open volume, the drainage cap comprising a first end defining a third opening and a second end defining a fourth opening, wherein the second seal is engaged with the fourth opening.

11. The fuel filter element according to claim 10, wherein the first seal is substantially within the open volume.

12. The fuel filter element according to claim 10, wherein the first seal is substantially within the first annular space.

13. The fuel filter element according to claim 10, wherein the first seal is engaged with the central opening.

14. The fuel filter element according to claim 10, wherein the first seal is engaged with the center tube.

15. A fuel filter element comprising:
an upper endcap incorporating an air bleed seal;
a lower endcap, defining a central opening and defining at least one flow opening radially outward of the central opening;
a substantially cylindrical formation of filter media extending between the upper endcap and the lower endcap and sealingly engaged with the upper endcap and the lower endcap and defining a first annular space;
a water separator at least partially within the first annular space and substantially axially aligned with the filter media;
a center tube, integrally formed with and radially surrounding the water separator, the center tube further comprising one or more ribs defining a second annular space between the filter media and the water separator, the second annular space being in fluid communication with the at least one flow opening;
a drainage cap configured to receive fluid through the at least one flow opening and defining an open volume, the drainage cap further comprising a first end defining a first opening, a second end defining a second opening, and a substantially cylindrical member offset radially from an axis located centrally within the second opening and projecting from the second end away from the lower endcap;
a first seal engaged with the first opening defining a third opening having a first diameter and configured to sealingly engage with a standpipe within a filter housing; and
a second seal engaged with the second opening and defining a fourth opening having a second diameter and configured to sealingly engage with the standpipe within the filter housing;
wherein the third opening is coaxial with the fourth opening, the second diameter is greater than the first diameter, and the first seal is offset from the second seal along the axis located centrally within the second opening.

16. An apparatus comprising:
a housing configured to receive a fuel filter element and further comprising a standpipe; and
a fuel filter element, further comprising an upper endcap, a lower endcap offset below the upper endcap and defining a central opening and at least one flow opening radially outward of the central opening, a tubular formation of filter media extending between the upper and lower endcaps and defining a first annular space, coaxial first and second seals supported by the fuel filter element and arranged to sealingly engage the standpipe when the fuel filter element is mounted over the standpipe within the filter housing, the coaxial first and second seals axially offset from the upper endcap and closer to the lower endcap than the upper endcap, the first seal having a first diameter and being axially offset from the second seal having a second diameter greater than the first diameter, a region between the first and second seals being in fluid communication with the at least one flow opening, and a pin supported below the lower endcap, radially outside the central opening and projecting away from the upper endcap;
wherein the housing defines a third opening configured to receive the pin.

17. The apparatus of claim 16, wherein the fuel filter element further comprises a water separator axially overlapping and substantially coaxial with the tubular formation of filter media, wherein the water separator is located radially inward of the filter media and defines a second annular space radially between the filter media and the water separator, the second annular space being in fluid communication with the at least one flow opening.
